(19) United States
(12) Patent Application Publication
(10) Pub. No.: US 2022/0134533 A1
(43) Pub. Date: May 5, 2022

(54) UPPER GRIP OF A MOP BROOM EQUIPPED WITH A ROTATING ELEMENT

(71) Applicant: TTS CLEANING S.R.L., Santa Giustina (IT)

(72) Inventor: Marco Zorzo, Onara (PD) (IT)

(73) Assignee: TTS CLEANING S.R.L., Santa Giustina (IT)

(21) Appl. No.: 17/416,900

(22) PCT Filed: Dec. 14, 2019
(86) PCT No.: PCT/IT2019/050269

§ 371 Date: Jun. 21, 2021

(30) Foreign Application Priority Data
Dec. 21, 2018 (IT) 102018000020749

(51) Int. Cl. B25G 1/10; A47L 13/42

(52) U.S. Cl. CPC B25G 1/10; A47L 13/42

(57) ABSTRACT

This invention concerns the upper grip of a cleaning broom with mops, which has a rotating knob on the upper end of a handle, which has a particular functionality.

### CROSS-REFERENCE TO RELATED APPLICATIONS

The present invention is a national stage application of PCT/IT2019/050269 filed on Dec. 14, 2019, which claims priority to IT 102018000020749, filed on Dec. 21, 2018, both incorporated by reference herein.

### STATEMENT REGARDING FEDERALLY SPONSORED RESEARCH AND DEVELOPMENT

Not Applicable.

### FIELD OF THE INVENTION

The object of this invention relates to the upper handle of a cleaning broom with mops equipped with a rotating element and characterized by particular functions.

### BACKGROUND

One of the most common cleaning tools is the broom for picking up dirt on the floor.

Traditionally a broom is a quite simple tool, consisting of a tubular shaft at whose lower end is fixed the specific base for the relative function.

The typical one includes a straight tubular wooden or metal shaft and a base with bristles.

Of course, with the evolution of performance requirements, especially in the professional sector, even the classic broom has been enhanced with accessory elements, it has been modified to be able to manage the mops with its own base, and also the method of its use has progressed.

Currently, therefore, the tubular shaft has a first handle at the upper end and a second handle positioned in the middle of the extension of the tubular shaft.

Also the tubular shaft, which in the past was traditionally straight, has undergone an evolution in a specific profile shaped in a bent manner, which allows cleaning following an S-shaped path, with a reverse direction of progression and advancement, i.e. towards the operator, moving it backwards.

With this method, both dry and wet, the floor is left completely clean with the progress of cleaning starting from the furthest away area of the areas to be cleaned, approaching the mop change point or its periodic cleaning or replacement, with the operator proceeding backwards, namely approaching the final point, with his back to you.

A highly valued upper handle configuration, in order to perform the aforementioned cleaning maneuvers, is the one that freely rotates, which allows you to avoid the continuous movement of the wrist of the hand which holds this upper handle, in order to correctly turn the base in the continuation of the cleaning movements.

However, this freely rotatable upper handle has a serious drawback, namely that a broom resting with its handle on a wall inevitably tends to fall on the floor forcing the operator to bend over to pick it up.

This drawback has meant that many professional operators have reconsidered this advantageous characteristic and have chosen to go back to a broom with a fixed upper handle.

### SUMMARY OF THE INVENTION

All the aforementioned purposes, and others which will be more readily seen from the following explanation, are achieved by the cleaning broom equipped with a rotating upper handle.

In particular, the broom of the invention consists of a tubular handle at the upper end of which is a rotating upper grip, consisting of a knob firmly fixed to the handle and a rotating knob joined with said knob at the free end of the handle, the knob being able to assume at least two positions, of which at least one is stable, a first lowered one, close to and adhering to the knob, free to rotate, and a second slightly raised one, disconnected from said knob in a locked condition without the possibility of rotating, where said knob, partially hollow, rotating and hinged on a pin solidly joined to the handle; on the inner circumferential surface of said knob there is a distributed series of anti-rotation devices capable of connecting with, in the passage from the first to the second position, corresponding anti-rotation devices on said handle or on said pin.

### ADVANTAGEOUS CHARACTERISTICS OF THE INVENTION

Advantageously, said pin or said knob show a first stop for limiting the movement of the first position of the knob equipped with a corresponding first stop element, for a compact and reliable construction of the device.

Advantageously, said pin or said knob show a second stop for limiting the movement of the second position of the knob equipped with a corresponding second stop element, with an equally reliable and compact construction of the device.

Advantageously, the second position is the stable position and is maintained by an elastic interference element between said handle or pin and said knob, being able to leave the handle of the broom equipped with the device of the invention resting on a wall without worrying that it may slip, falling on the floor.

Advantageously, said elastic interference element is an elastic support that supports said anti-rotation devices, creating a compact system both for maintaining the second position in a stable manner, and for locking this position, preventing it from rotating.

Advantageously, said anti-rotation devices are configured as a series of protruding teeth with the axis of the generatrix coinciding with the main axis of the handle and the knob, being able to provide an effective and reliable locking of the rotation of the knob without additional encumbrances.

Advantageously, said knob is coated on the outside with a soft material that has a high friction coefficient, or a grip, such as rubber or silicone, thus being able to remain resting against the palm of the operator's hand while pushing in the axial direction to maneuver the broom in the S-shaped movement.

Advantageously, said coating of soft material on the outer surface of the knob provides better friction against the wall against which the broom is resting against with its handle, preventing it from falling to the ground even if it is in an inclined position.

Advantageously, the movement of the knob from an unlocked position, free to rotate to a locked condition, where it is prevented from rotating, is easily achieved by the operator using just one hand, held closed on the grips and using the thumb to move the knob upwards into the locked position.

Advantageously, the device includes elastic devices between the knob and the handle which keep the knob pushed into the second stable position.

Advantageously, said elastic devices counteract the pushing of the operator on the outside of the knob in the direction of the handle, a push following which the knob reaches the first lowered position, thus resulting in the knob being free to rotate with respect to the handle during cleaning operations.

Advantageously, upon termination of the aforementioned pushing of the operator, the knob under the action of said elastic devices takes up the second stable configuration by passing to the first free position for rotation to the second locked position, and is prevented from rotating.

Advantageously, alternatively or in combination with said elastic devices, the first position is also a stable position for overcoming an initial interference between said knob and said handle, making said first position a position that is permanently free to rotate.

These and other objects are all attained by the upper handle of the mop broom equipped with a rotating element that is the object of this invention according to the attached claims.

### DESCRIPTION OF THE DRAWINGS

FIG. 1 shows a perspective view of only the upper part of a cleaning broom, and in particular the upper grip comprising the rotary knob on a handle fixed to the tubular handle of the cleaning broom;

FIG. 2 shows an enlargement of the pivoting pin of the upper knob, where this is removed for clarity of exposition, and where said pin is fixed to the upper end of the knob and that bears the anti-rotation devices on a limited circumferential arc;

FIG. 3 shows a section passing through the main symmetry axis of the knob, making it clear that the said anti-rotation devices are arranged on an elastic support element;

FIG. 4 shows what is set out in FIG. 3 completed, likewise sectioned along the same section plane, with the knob hinged on the rotation pin;

FIG. 5 shows what is set out in FIG. 4, corresponding to a different section plane;

FIG. 6 shows only the knob and the handle, corresponding to a view with the same section plane of FIG. 4, without the pin and the knob for the sake of clarity, where the presence of the anti-rotation devices arranged circumferentially on the internal surface of the knob is evident;

FIG. 7 shows a particularly enlarged detail of the anti-rotation devices on the outer surface of the pin, with evidence of the teeth extending according to a generatrix with its axis parallel to the main axis of the pin;

FIG. 8 shows a vertical section, and in a perspective manner, the top handle with a knob and interposed elastic devices to make the second position of the knob a stably maintained position, as long as it is not subjected to external stresses, and in a raised configuration with respect to the handle;

FIG. 9, in conformity with FIG. 8, shows a perspective view of the same vertical section, where the elastic devices interposed between the knob and the handle are compressed, by stress applied externally on the outside of the knob, in the direction of the handle, bringing the knob to the first position, following a translation movement from the second position to the first position, free to rotate, close to the knob; and

FIG. 10 shows a broom accessorized at the upper end of the handle with an upper grip that is the object of the invention, where the advantageous S-shaped cleaning movement, which can be easily carried out by the operator, is highlighted.

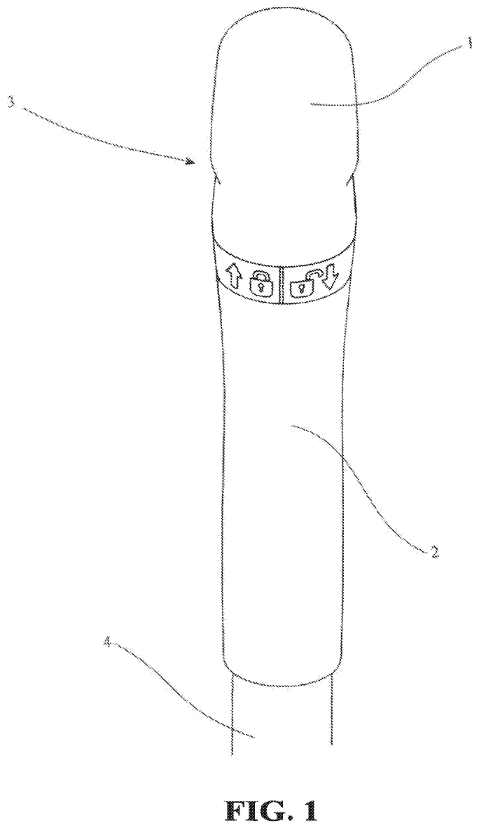

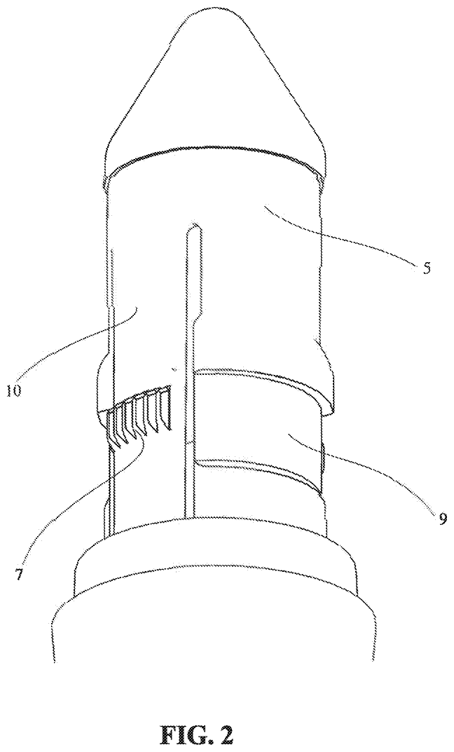

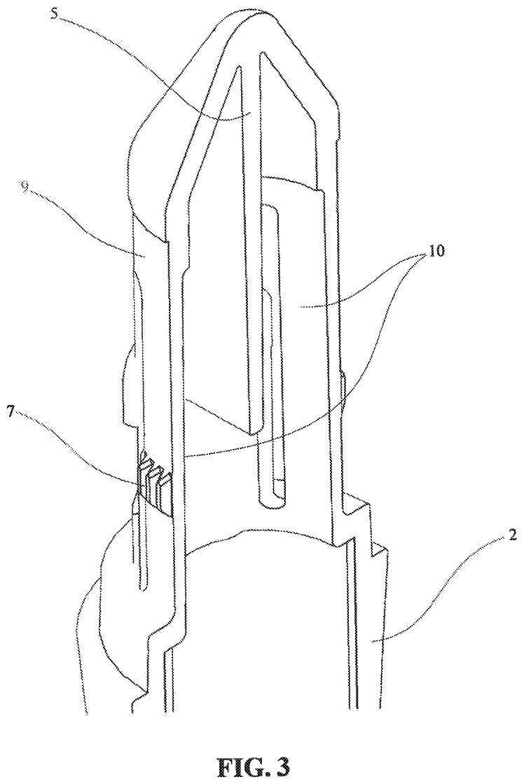

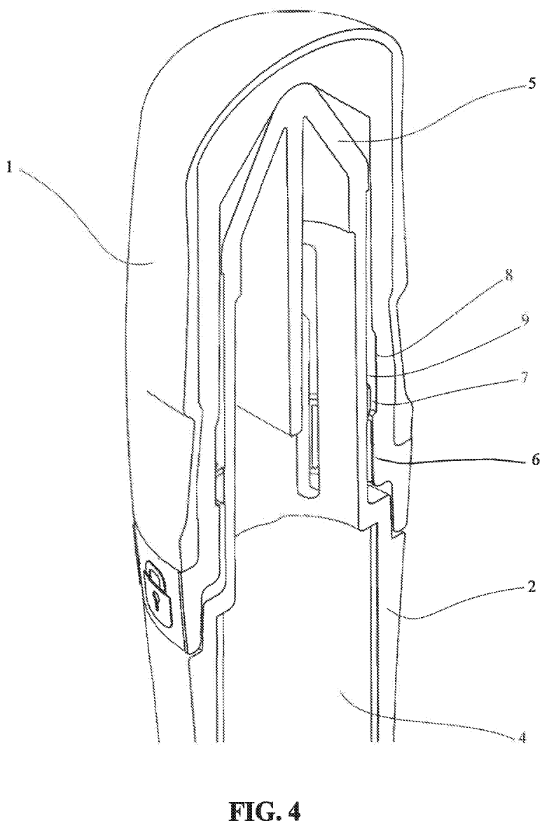

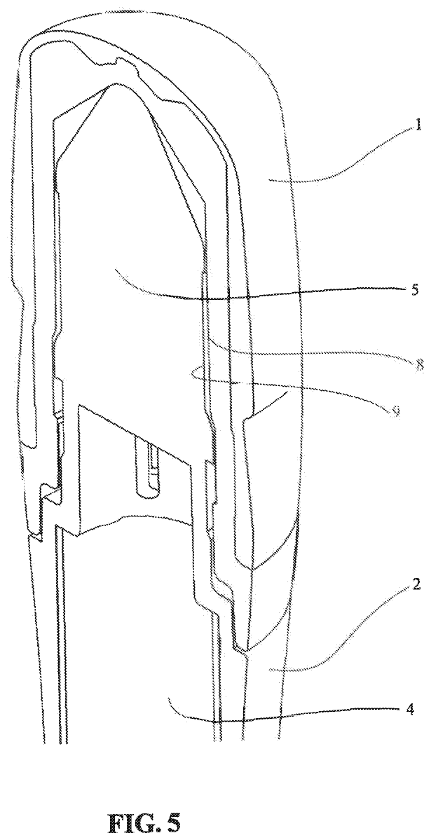

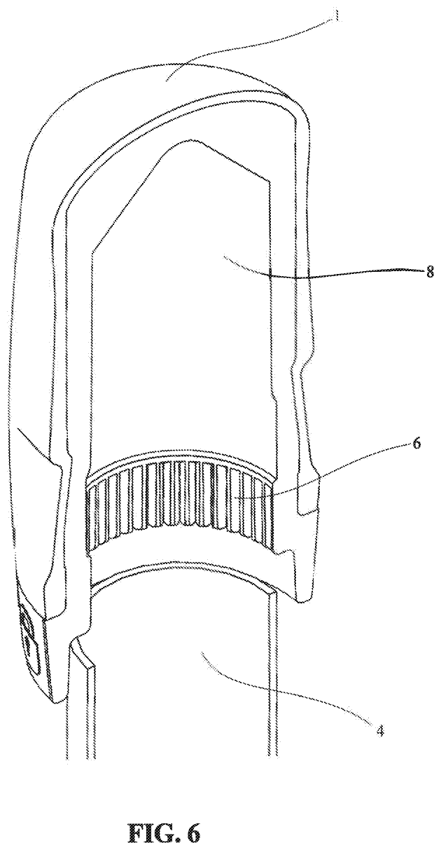

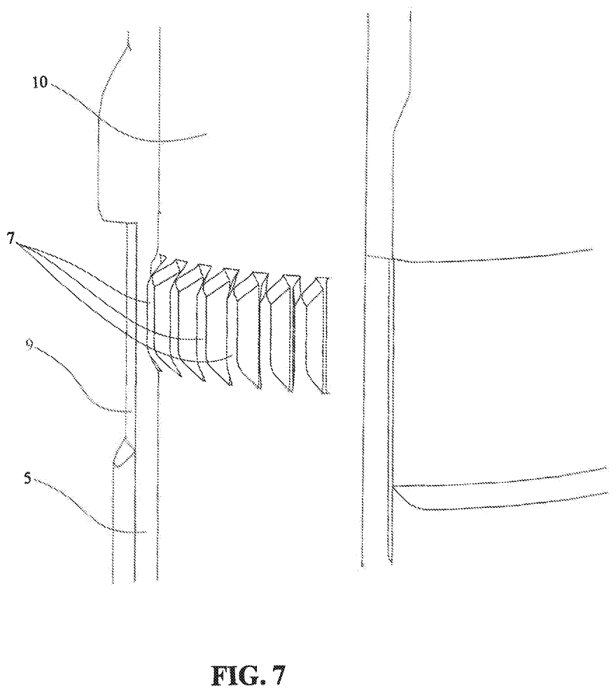

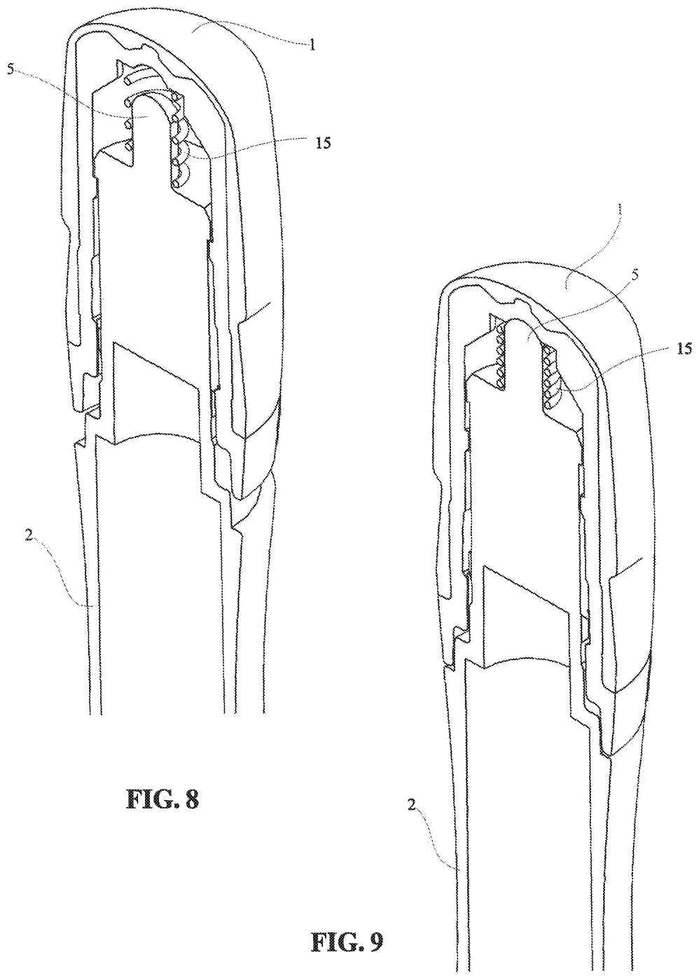

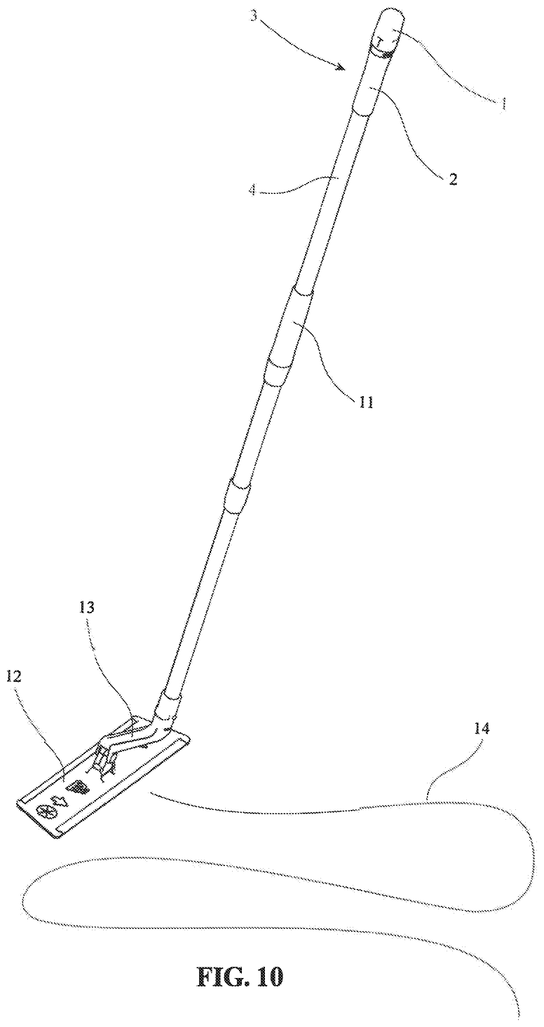

### DETAILED DESCRIPTION OF THE PREFERRED EMBODIMENT

With reference to the figures, the cleaning broom has, at the upper end of the handle 4, an upper grip 3 composed of a handle 2 to which a knob 1 is superimposed.

Said handle 2 is joined to the handle 4 in a fixed manner.

The knob 1 is joined to the handle 2 in a movable manner so that it can assume two configurations, a first configuration with the possibility of rotating freely, and a second configuration that is locked, with no possibility of rotating.

In particular these two configurations, the fixed and locked one, correspond to a raised position exposed towards the outside, in a direction opposite to that of the handle 4, while the one free to rotate corresponds to the configuration close to the handle 2, in the direction of the handle 4; the passage from the first to the second, and also from the second to the first position, takes place following a movement of the knob relative to the handle; said change of position consists of a translation movement along the pivoting axis of said knob.

To be able to rotate freely, knob 1 is hinged on a pin 5, coaxial and protruding towards the upper end of the handle 2.

The passage from the free rotation configuration to the locked configuration of the knob 1, with respect to the handle 2, takes place by a slight axial shift along the pin 5, namely with a translation movement parallel to the main axis of the handle 2.

With this axial shift, the first anti-rotation devices 6 on the inner circumferential surface 8 of the knob 1 are joined with the second anti-rotation devices 7 on the outer surface 9 of pin 5.

Said anti-rotation devices 6, 7 are configured as a series of protruding teeth parallel to the main axis of symmetry of the pin 5 rotating the knob 1.

To realize the locked configuration of the knob 1, and to make it a stable configuration, said second anti-rotation devices 7 are placed on an elastic support 10, so that the retention of the knob 1 takes place by interference of the anti-rotation devices 6, 7 with a constant and continuous pressure, preventing the knob 1 from easily going down, with a translation movement, along the main axis of symmetry of the pin 5, eliminating the mutual connection between the first and second anti-rotation devices 6, 7.

The two configurations are conveniently reached and limited by a stop element, present indifferently on the pin or on the handle or on the shaft, which defines and limits the movement of the knob 1 from the configuration that is free to rotate to the one that is locked and vice-versa.

With the aforesaid structuring of the knob 1 that can rotate with respect to the shaft, the advantageous characteristic is obtained so that the operator can act by pushing on the knob 1, with a hand or with the palm of a hand, but without using the wrist to create a rotation force on the handle 4 to direct the arrangement of the base 12 of the broom, or even simply without rotating the wrist of the hand on the upper handle 3, to leave this task to the other hand of the operator who grasps the second grip 11 approximately in the middle of the handle 4 of the broom.

With the aforementioned configuration, and also due to the presence of a deformed profile 13 of the handle near the connection of the straight shaft 4 with the base 12, progression and advancement of a reverse type, that is towards the operator, who moves backward.

Another advantageous characteristic is obtained with the different configuration of the knob 1, the one with the knob raised, and moved slightly upwards before the cleaning broom is rested with the knob 1 against the wall.

In fact, in this raised configuration the knob 1 is no longer free to rotate, but remains locked, preventing the broom resting on the wall from slipping and falling onto the floor; this aspect can be further improved with the adoption of a material with a high friction coefficient or grip, such as for example a soft rubber or soft polyurethane or a gel.

The passage from one configuration to the other also respects the course of the operations, and is therefore highly ergonomic, since it does not leave the operator uncertain about the operations to be carried out, which are undertaken with the natural progress of the work.

In fact, from a broom resting against a wall, and therefore with a knob 1 raised in a locked position, the operator, in order to apply pressure to the cleaning cloth, using the base 12 of the broom presses through the shaft 4 with the palm of the hand on the knob 1, which drops towards the handle 2 and comes to rest on a stop element, on the same handle 2 or on the pin 5 or on the handle 4, to attain the configuration that is free to rotate.

Vice-versa, if the work has to be suspended and the operator wants to rest the broom against the wall with a quick movement, he raises the knob 1 with a small shift that locks the knob 1 due to interference between the anti-rotation devices 6, 7, immediately reaching the aim and leaving the broom against the wall with the certainty that it will not fall to the floor by sliding along the wall.

As an alternative to the aforementioned structure, which involves an intervention by the operator who has to shift the knob 1 from the first lowered position to the second raised position, and vice-versa, whenever they intend to place the handle 4 of the broom against the wall, or from such support re-take the broom to start or continue cleaning operations, it is expected that this movement will be automatically carried out by an automatic positioning of the knob 1 in the locked position, after having been moved to the first free rotation position, and is kept in this second position. Both said automatic return and maintenance of the second position are attained by the elastic devices 15 described below.

Advantageously, the aforesaid operation carried out by the operator in raising the knob 1, after the cleaning operations, to make it impossible for the knob to rotate on the pin, and to be able to securely rest it against the wall without the risk that it can rotate on the wall, causing the shaft to fall on the ground, is achieved by the presence of elastic devices 15, in the example shown this is a spring set coaxially to the pin 5, interposed between knob 1 and handle 2.

Said elastic devices 15, once the action of the operator is finished, in pushing on the knob 1 during the cleaning operations, along the axis and in the direction of the shaft 4, return the knob 1 from the position close to the handle 2, and therefore free to rotate, to the second position that is raised with respect to the handle 2 and locked out of the possibility of rotating, without the need for the operator, whenever they want to rest the handle 4 with a grip 3 against a wall, manually shift the knob 1 from the first to the second position.

Therefore, said second position can be considered a stable position, kept in this condition either by coupling due to the interference of the anti-rotation devices 6,7 arranged on the elastic support 10, or else by the presence of said elastic devices 15.

The first position of the knob 1, on the other hand, can be considered a stable position of the knob 1 in the event that it corresponds to a lowered position, after overcoming the retention due to the interference of the anti-rotation devices 6, 7, constituted by the elastic support 10. Unlike said first position, in the presence of said elastic devices 15, a non-stable position is maintained only because of a compression action that exceeds the force of said elastic devices 15, acting on the outside of the knob 1 and with a direction towards the handle 4.

Obviously, the presence of these elastic devices 15 can also supplement the function carried out by the elastic support 10 on which the anti-rotation devices are arranged.

Therefore, as an alternative to the elastic support 10, the retention of the anti-rotation devices 6, 7 in mutual constraint is ensured by the action of said elastic devices 15.

1. An upper grip of a mop handle for a mop comprises a handle firmly fixed to the mop handle, a rotating knob joined to said handle at a free end of the handle wherein said rotating knob having two positions, one position lowered, close to and adhering to the knob, free to rotate, and a second position raised, away from said knob in a rotationally locked position, where said knob is partially hollow, rotating and hinged on a pin firmly attached to the handle; a distributed series of first anti-rotation devices disposed on an inner circumferential surface of said knob that can joinwith, in the transition from the first position to the second position, corresponding second anti-rotation devices on said handle or on said pin.

2. The upper grip of claim 1 wherein said pin or said handle include a first stop element for limiting the movement of the first position of the knob equipped with a corresponding first stop element.

3. The upper grip of claim 1 wherein said pin or said handle include a second stop element for limiting the movement of the second position of the knob having a corresponding second stop element.

4. The upper grip of claim 1 wherein said second position is a stable position.

5. The upper grip of claim 4 wherein said second position is maintained by interference of an elastic element between said handle or pin and said knob.

6. The upper grip of claim 1 wherein said elastic element supports said anti-rotation devices.

7. The upper grip of claim 1 wherein said anti-rotation devices are configured as a series of protruding teeth with an axis of a generatrix coinciding with the main axis of the handle and the knob.

8. The upper grip of claim 1 wherein said knob is coated on the outside with a soft material with a high friction coefficient, or with a grip that includes rubber or silicone.

9. The upper grip of claim 1 wherein said first position is stable.

10. The upper grip of claim 1 wherein elastic devices are interposed between the knob and the handle, which keep the knob in the second stable position, and, whereby compression exerted on the outside of the knob and in the direction of the handle overcomes the elastic force of said elastic device, allowing the knob, following a translation movement, to assume the first position.
